(19) United States
(12) Patent Application Publication
(10) Pub. No.: US 2005/0008765 A1
(43) Pub. Date: Jan. 13, 2005

(54) Method for monitoring quality of paper web

(75) Inventor: Jari-Matti Karjanmaa, Hyvinkaa (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Metso Automation Oy

(21) Appl. No.: 10/842,255

(22) Filed: May 10, 2004

Related U.S. Application Data
(63) Continuation of application No. 09/916,410, filed on Jul. 27, 2001, now abandoned.
Application No. 09/916,410 is a continuation of application No. PCT/FI00/00059, filed on Jan. 28, 2000.

(30) Foreign Application Priority Data
Jan. 28, 1999 (FI) 990159

(51) Int. Cl. B05D 3/12

(52) U.S. Cl. 427/8; 427/361

(57) ABSTRACT

A paper web exiting a paper manufacturing machine is monitored on a continual basis, either substantially continuously or at periodic intervals, by imaging the web with a thermal camera operating in the infrared spectrum in order to detect defects such as wet spots, patches, or streaks in the base paper web and/or irregularities in a coating layer applied to the paper web in a downstream coating unit. Based on the detected defects, the manufacturing process and/or subsequent treatment process can be adjusted to eliminate the defects.

### CROSS-REFERENCE TO RELATED APPLICATION

This application is a continuation of U.S. application Ser. No. 09/916,410, filed Jul. 27, 2001, which is a continuation of International Application No. PCT/FI00/00059 filed Jan. 28, 2000 and which International Application was published by the International Bureau in English on Aug. 3, 2000, both of which are hereby incorporated herein in their entirety by reference.

### FIELD OF THE INVENTION

The invention relates to a method for monitoring the quality of a paper web in a continuous process in which the paper web exiting the paper manufacturing machine is conveyed for subsequent treatment.

### BACKGROUND OF THE INVENTION

Depending on the final use of the paper, a paper web being manufactured on a paper machine can be treated in a variety of ways even when the web is relatively dry. For instance, when manufacturing common newsprint, its surface is smoothed with a so-called machine calender, whereby sufficient surface smoothness for printing is achieved quickly and economically without coating. Certain magazine paper grades in turn require coated paper, and hence the paper web is coated with coating paste that may contain, for instance, china clay or talcum. Very often the coated paper grades are also calendered after coating in order to smooth them.

Currently, the paper web calendering and coating processes can pose a number of quality problems that can result in products that are of poor or varying quality, or worse still, in damaging the equipment, particularly the polymer surfaces of calender rolls. Such problems can result in interruptions in production and repair costs.

In online calendering, the web is smoothed as it exits the paper machine. In online coating, the web exiting the paper machine is conveyed directly to a coating unit and then to a calendering unit to produce a finished coated web.

Frequent problems that can occur in manufacturing and subsequent treatment of the web include the formation of wet spots and patches where the web is unbroken but wetter than desired. These result in web curling and waviness in the final product. Likewise, in conjunction with coating, problems with runability and consequently interruptions in production can occur as a result of small-scale variations in the amount of coating applied, which results from the fact that the coating attaches to dry areas of the web in a different manner than to wet spots. Because this coating variation is irregular in occurrence, it may go undetected in laboratory tests. Moreover, in the worst case, the coating applied over wet spots in the web may not properly adhere to the base paper of the web, and may become detached in the calendering stage and stick to the polymer surface of a calender roll. This can cause a hot area to form on the polymer surface of the roll and destroy the roll's polymer surface material.

Furthermore, narrow, less than 10 mm wide, wet streaks can appear in the web, as a result of which the paper web can shrink unevenly, and consequently the runability through the whole paper machine, also the coater and later the cutters, can deteriorate and waves may form in sheet piles. A further problem that can occur is that the amount of coating applied can vary in different ways and can produce streakiness in the final product. Also in this case the coating at the streaks may adhere to a calender roll, as a result of which the roll's surface material can heat up locally and be completely destroyed.

Irregular and rapid deviations may also occur in coating, which are a common cause of quality variations in coated papers. In post-coating calendering, the coating material may stick to the calender rolls if it is not fully dried, since drying of the coating is commonly carried out according to an average amount of coating, and hence areas of coating that are thicker than average may not fully dry before calendering is performed. With time, this may damage the roll's surface material and necessitate a roll change. The CD or MD profile of the paper may also vary excessively. These profile defects may be produced in the wire section as a result of wire or felt congestion, or in the press section, e.g., by the action of fouled press rolls. These conditions affect the paper formation and thereby the paper profile. In the drying section, suction rolls may produce streaks in the web and thereby affect the profile.

Defect detectors used in paper mills are often based on visible light or on measuring the temperature and moisture of the web. These measurements are typically performed with slow-response, spot-like sensors. These enable monitoring of long-term variations in the web, but quickly changing defects and deviations remain unnoticed in practice.

German Patent DE 19 63 2988 discloses a solution, in which clearly visible defects, such as tears, light or dark spots, etc., are sought in the web with a conventional video camera by means of bright light. This publication also discloses a solution in which the web is monitored either by a conventional IR sensor beam or conventional CCD cameras in order to find similar defects visible to the naked eye and to mark them in the web by spraying a marking substance on the areas of defects. However, these solutions described in the publication do not allow monitoring moisture defects in the web or variations in the amounts of coating, both of which are often extremely harmful.

### SUMMARY OF THE INVENTION

The object of the present invention is to provide a method by which the web quality can be monitored more reliably than previously and the causes of various defects can be found in fault situations, whereby they can be eliminated. In accordance with the invention, the moving paper web exiting the paper manufacturing machine is imaged on a continual basis with a thermal camera prior to and/or after a subsequent treatment process for the web in order to detect defects in the paper web, and on the basis of the detected defects the manufacturing process of the paper web and/or the treatment process is adjusted.

In one embodiment, the paper web is conveyed from the paper machine directly to a coating unit. Before and/or after coating, the web is monitored substantially continuously with a camera operating within an infrared region, preferably from 3 to 12 micrometers in wavelength. Monitoring can be implemented both as continuous imaging displayed on a monitor and as recording of a camera image such that when a defect or a possible damage appears, it is possible to find the cause of the defect so that it can be eliminated in one way or another. One preferred embodiment of the invention employs a camera that shows a continuous, non-stop picture of the web. Another preferred embodiment of the invention employs a camera that takes a so-called still picture of the web at suitably frequent intervals so that if a defect appears it can be quickly addressed in an appropriate manner. In particular, the invention is applicable to quality control of the web that is already coated or is being coated.

An advantage of the invention is that the quality of the finished web product can be ensured. At the same time, it is possible to quickly get information on undesirable deviations occurring in the process and on the basis thereof the process can be quickly adjusted. Likewise, in situations that may have serious consequences the process can be stopped, the calender can be opened quickly if necessary, or other appropriate action can be taken, in order to minimize the cost incurred. The method of the invention further allows detecting possible, dangerous deviations in the web in conjunction with online calendering and thus tracing the origin of the deviation.

### BRIEF DESCRIPTION OF THE DRAWINGS

The above and other objects, features, and advantages of the invention will become more apparent from the following description of certain preferred embodiments thereof, when taken in conjunction with the accompanying drawings in which:

FIG. 1 shows a schematic view of equipment applicable to the implementation of the method of the invention;

FIGS. 2a and 2b are images of quality deviations in an uncoated web detected with the equipment of FIG. 1;

FIG. 3 shows deviations in the uncoated web detected after so-called intermediate calendering;

FIG. 4 shows the web at the coating station; and

FIG. 5 shows the coated web.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

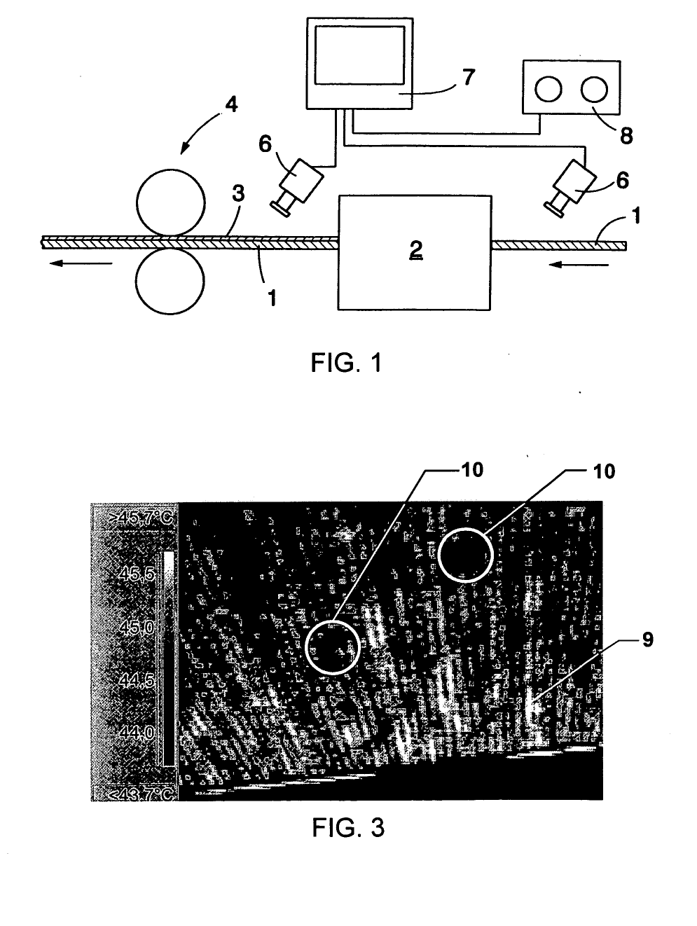

FIG. 1 is a schematic view of equipment applicable to the implementation of the method of the invention. In the figure, an uncoated web 1 exiting a paper machine is conveyed to a coating unit 2. In the coating unit 2, a coating 3 is applied onto the surface of the web 1, whereafter the coated web is conveyed to a calendering unit 4 and therefrom to further processing. In the coating unit, coating is applied on the web and spread such that the coating layer on the web is substantially even. In calendering, the coated web is conveyed between hot rolls such that it becomes as even as possible and dries further. In general, the calender rolls are coated with a polymer surface material that is sufficiently elastic and enables even pressing during the calendering.

To implement the method of the invention, the equipment comprises one or more cameras 5 and 6 operating within the infrared region. With these cameras the web 1 can be imaged before and/or after coating. From the camera or cameras 5, 6 the image is conveyed to a monitor 7, for instance, which the operation controller of the equipment can watch. Additionally or alternatively, the image can be conveyed to a recorder 8 that records the image provided by the camera or cameras substantially continuously.

When deviations of a given type, such as wet spots or patches, streaks of moisture, etc., are detected in the web 1 or irregularities are detected in the amount of coating, the process can be immediately adjusted, or can be stopped if there is reason to assume that the detected defects might cause serious damage and thereby costs to the equipment. On the basis of the deviations and defects it is further possible to trace the origin of the deviation and hence the quality of the process and its end product can be improved and the interruption and damage costs incurred can be substantially reduced or avoided.

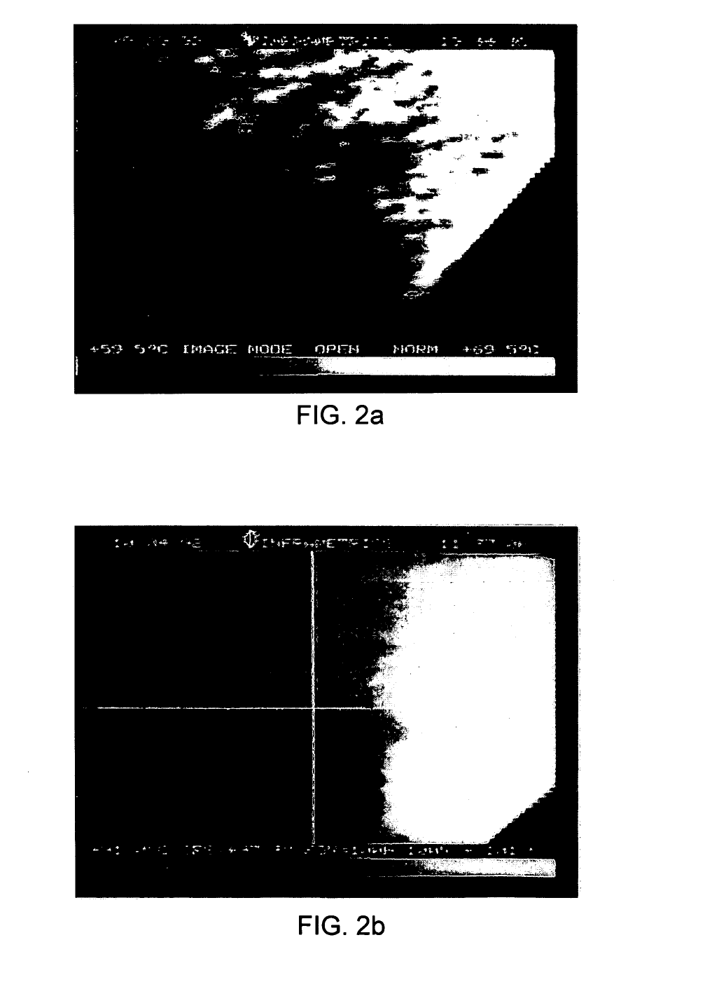

FIGS. 2a and 2b show defects detected with the equipment of FIG. 1. The images have been taken of the base paper of the web 1 before it is conveyed to a coating station. FIG. 2a shows how the moisture level of the web exiting a machine that is in need of service, for instance a machine having congested felts, can be high and variations can be considerable. Conventional online paper measuring devices based on spot detection cannot detect these defects. In contrast, FIG. 2b shows an image of a paper web in which moisture variations are minor, which indicates that the felts and the paper machine are serviced and in good condition.

FIG. 3 shows narrow streaks of moisture in the web 1, i.e., in the base paper. This image was taken of the web 1 after so-called intermediate calendering, and the narrow streaks of moisture indicated by reference numeral 9 are clearly visible. Black spots, indicated by reference numeral 10, also appear in the image, which reveal irregular quality deviations in the web 1.

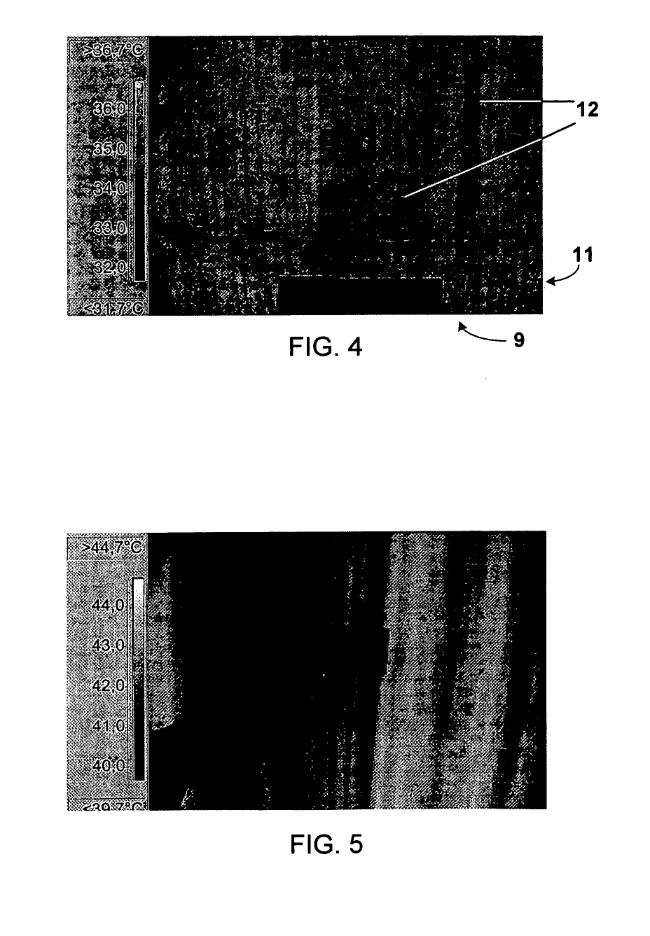

FIG. 4 shows the web, i.e., the base paper, at the coating station, and the image reveals a number of different facts. Striping caused by the rolls is indicated with the reference numeral 9 as in FIG. 3. A marking 11 caused by a felt seam also appears in the image. A pattern 12 produced by latex spots on the opposite side of the web also appears in the image, which indicates defects in the coating.

In FIG. 5, the amount of coating varies in different parts of the web. In this case, there is clearly more coating in some areas than in others, and consequently, the coating dries more slowly in these areas than elsewhere in the paper. As a result, the coating may still be too wet in calendering, and hence the coating may stick to the calender roll's surface and cause damage over time.

The images shown herein by way of example were taken by a camera operating within an infrared region of 3 to 12 micrometers in wavelength. The measuring regions are preferably from 3 to 5 micrometers or 8 to 12 micrometers, whereby various defects and deviations can be detected in a variety of ways. However, it is essential that by using a thermal camera operating within the infrared region in this manner various defects and deviations can be detected both in the uncoated web and in the coating material of the coated web, which defects and deviations may cause quality variations in the product or even damage to the coating equipment, in particular, in the calender roll's surface material and thus inflict considerable expenses on production, both as downtime and as repair costs of the equipment.

In the above specification and drawings, the invention has only been described by way of example and it is by no means restricted thereto. It is substantial that the quality of the web to be coated is monitored substantially continuously with cameras operating within the infrared region either such that the web exiting the paper machine is monitored before coating or the quality of the coating material of the coated paper is monitored before calendering such that the manufacturing process of the paper web product can be adjusted either on the actual paper machine or in the treatment thereafter in order to obtain a product of as high quality as possible.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for monitoring and controlling quality of a paper web as the paper web is being manufactured, comprising:
conveying the paper web through a paper machine where the paper web is formed as part of a manufacturing process and treating the paper web by subjecting the paper web to a treatment process;
imaging the paper web with a thermal camera on a continual basis;
displaying the images to a human operator in real time;
analyzing images from the thermal camera in real time as the images are captured by the thermal camera on a continual basis in order to detect defects in the paper web based on the images; and
adjusting in real time at least one of the manufacturing process and the treatment process for the paper web based on input from the human operator, wherein the input from the operator is based on defects determined from the images.

2. The method of claim 1, wherein the step of subjecting the paper web to a treatment process comprises coating the paper web with a coating material.

3. The method of claim 1, wherein the step of subjecting the paper web to a treatment process comprises calendering the paper web.

4. The method of claim 2, wherein the paper web is imaged prior to the treatment process.

5. The method of claim 2, wherein the paper web is imaged after the treatment process.

6. The method of claim 2, wherein the paper web is imaged both prior to and after the treatment process.

7. The method of claim 3, wherein the paper web is imaged prior to the treatment process.

8. The method of claim 3, wherein the paper web is imaged after the treatment process.

9. The method of claim 3, wherein the paper web is imaged both prior to and after the treatment process.

10. The method of claim 1, wherein images of the paper web taken by the thermal camera are used in order to detect nonuniformities in a characteristic of the paper web.

11. The method of claim 10, wherein the images are used to detect nonuniformities in wetness of the paper web.

12. The method of claim 10, wherein the images are taken after the paper web is coated with a coating layer, and the images are used to detect nonuniformities in the coating layer.

13. The method of claim 1, wherein the imaging is performed within the infrared light spectrum of 3 to 12 micrometers in wavelength.

14. The method of claim 1, wherein the imaging is performed within the infrared light spectrum of 3 to 5 micrometers in wavelength.

15. The method of claim 1, wherein the imaging is performed within the infrared light spectrum of 8 to 12 micrometers in wavelength.

16. The method of claim 1, wherein the web is conveyed to a coating unit in which a coating layer is applied to the paper web, and the coated paper web is then conveyed to a calendering unit in which the web is calendered, and wherein the coated paper web is imaged prior to entering the calendering unit in order to detect irregularities in the coating layer.

17. The method of claim 1, wherein images of the paper web taken with the thermal camera are displayed on a monitor to enable continuous monitoring during manufacturing and treatment of the paper web.

18. The method of claim 1, wherein an image of the paper web taken with the thermal camera is stored in a memory for further analysis.

19. A method for monitoring and controlling quality of a paper web as the paper web is being manufactured, comprising:
conveying the paper web through a paper machine where the paper web is formed as part of a manufacturing process and thereafter treating the paper web by subjecting the paper web to a treatment process;
imaging the paper web with a thermal camera in real time as the paper web is manufactured;
displaying the images to a human operator in real time;
analyzing images from the thermal camera in real time as the images are captured by the thermal camera to detect defects in the paper web based on the images; and
adjusting in real time at least one of the manufacturing process and the treatment process for the paper web based on input from the human operator, wherein the input from the operator is based on defects determined from the images.

20. A method for monitoring and controlling quality of a paper web as the paper web is being manufactured, comprising:
conveying the paper web through a paper machine where the paper web is formed as part of a manufacturing process and thereafter treating the paper web by subjecting the paper web to a treatment process;
imaging the paper web with a thermal camera as the paper web is manufactured;
displaying the images to a human operator;
analyzing images from the thermal camera as the images are captured by the thermal camera;
detecting defects in the paper web directly from the images as they are captured such that there is not a requirement to store the images for later analysis; and
adjusting in real time at least one of the manufacturing process and the treatment process for the paper web based on input from the human operator, wherein the input from the operator is based on defects determined from the images.
